(19) United States
(12) Patent Application Publication
(10) Pub. No.: US 2021/0297819 A1
(43) Pub. Date: Sep. 23, 2021

(54) METHOD FOR IDENTIFYING EXISTING GROUPS, ELECTRONIC DEVICE AND GROUP DEVICE

(71) Applicant: Coretronic Intelligent Cloud Service Corporation, Hsin-Chu (TW)

(72) Inventors: Hsing-Yu Chen, Hsin-Chu (TW); Yi-Bin Yang, Hsin-Chu (TW)

(73) Assignee: Coretronic Intelligent Cloud Service Corporation, Hsin-Chu (TW)

(21) Appl. No.: 17/206,150

(22) Filed: Mar. 19, 2021

(30) Foreign Application Priority Data
Mar. 20, 2020 (CN) 202010199365.7

(51) Int. Cl. H04W 4/08; H04M 1/72469; G06F 3/0481

(52) U.S. Cl. CPC H04W 4/08; G06F 3/04817; H04M 1/72469

(57) ABSTRACT

The invention provides a method for identifying existing groups, an electronic device and a group device. The method includes: broadcasting a request signal in response to determining that a group identification function of the electronic device has been started, wherein the request signal is configured to trigger a first group device to display a first group pattern, and the first group pattern corresponds to a first group which the first group device belongs to; detecting a first identification signal from the first group device, wherein the first identification signal indicates the first group pattern of the first group; and displaying a first group option corresponding to the first group, wherein the first group option indicates the first group pattern.

### CROSS-REFERENCE TO RELATED APPLICATION

This application claims the priority benefit of China application serial no. 202010199365.7, filed on Mar. 20, 2020. The entirety of the above-mentioned patent application is hereby incorporated by reference herein and made a part of this specification.

### BACKGROUND OF THE INVENTION

### 1. Field of the Invention

The invention relates to an identifying method, an electronic device and a group device, in particular to a method for identifying existing groups, an electronic device and a group device.

### 2. Description of Related Art

In the related art, various consumer electronic devices mostly communicate with users through visual contents. In electronic devices such as a desktop computer, a mobile phone, a laptop, a tablet computer and a television, the visual contents play a leading role in interaction between the electronic devices and the users.

With the development of technologies, a lot of peripheral devices all can do communication through different forms of communication modes, and from connecting line connection in the early stage to various forms of networks today, the interaction of the electronic devices becomes more and more diverse. For example, consumer electronic products around in daily life already possibly communicate online in groups through the networks, and therefore, how to quickly identify which devices are communicating with each other is quite important. A relatively common example is identifying which wireless network is the laptop being connected to.

In the related art, pairing of two or multiple devices is mostly displayed in text so as to be identified by the users when identified. For example, identification marks are displayed in the prominent position (such as a center) of a picture, while all devices in the same group may utilize their pictures to display the same name or the same large-scale number as difference. However, this mode easily causes visual interference to the users, and may influence current operation behaviours of the users.

The mode of displaying group information in text is also less friendly to the users.

In addition, although there is a method for displaying the group information in a watermark mode nowadays, the users must find other devices displaying the same information, and this is more difficult to identify for devices (such as the mobile phone) with relatively small display pictures.

The information disclosed in this Background section is only for enhancement of understanding of the background of the described technology and therefore it may contain information that does not form the related art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

For this reason, the invention provides a method for identifying existing groups, an electronic device and a group device, which may be configured to solve the above technical problems.

The invention provides a method for identifying existing groups, suitable for an electronic device, and including: broadcasting a first request signal in response to determining that a group identification function of the electronic device has been started, wherein the first request signal is configured to trigger at least one first group device to display a first group pattern, and the first group pattern corresponds to a first group which the at least one first group device belongs to; detecting a first identification signal from the at least one first group device, wherein the first identification signal indicates the first group pattern of the first group; and displaying a first group option corresponding to the first group, wherein the first group option indicates the first group pattern.

The invention provides a method for identifying existing groups, suitable for a group device belonging to a first group, and including: broadcasting a first identification signal, wherein the first identification signal indicates a first group pattern corresponding to the first group; and displaying the first group pattern in response to determining that a first request signal from an electronic device is detected.

The invention provides an electronic device, including a storage circuit and a processor. The storage circuit stores a plurality of modules. The processor is coupled to the storage circuit, and accesses the foregoing modules to perform:

broadcasting a first request signal in response to determining that a group identification function of the electronic device has been started, wherein the first request signal is configured to trigger at least one first group device to display a first group pattern, and the first group pattern corresponds to a first group which the at least one first group device belongs to; detecting a first identification signal from the at least one first group device, wherein the first identification signal indicates the first group pattern of the first group; and displaying a first group option corresponding to the first group, wherein the first group option indicates the first group pattern.

The invention provides a group device, including a storage circuit and a processor. The storage circuit stores a plurality of modules. The processor is coupled to the storage circuit, and accesses the foregoing modules to perform: broadcasting a first identification signal, wherein the group device belongs to a first group, and the first identification signal indicates a first group pattern corresponding to the first group; and displaying the first group pattern in response to determining that a first request signal from an electronic device is detected.

Based on the above, the method for identifying the existing groups, the electronic device and the group device of the invention can make a user of the electronic device identify a group which the electronic device is about to join more easily.

To make the features and advantages of the invention clear and easy to understand, the following gives a detailed description of embodiments with reference to accompanying drawings.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic system architecture diagram drawn according to an embodiment of the invention.

FIG. 2 is a flow diagram of a method for identifying existing groups drawn according to an embodiment of the invention.

FIG. 3 is a schematic application situation diagram drawn according to FIG. 1.

FIG. 4A and FIG. 4B are schematic diagrams of other group patterns drawn according to FIG. 3.

FIG. 5 is an application situation diagram drawn according to an embodiment of the invention.

### DESCRIPTION OF THE EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

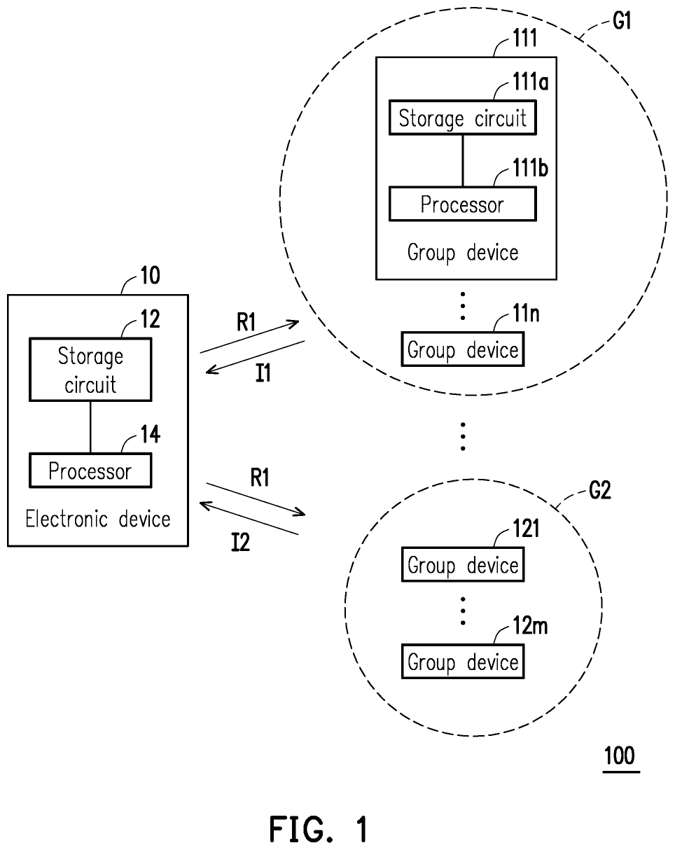

Referring to FIG. 1, which is a schematic system architecture diagram drawn according to an embodiment of the invention, as shown in FIG. 1, a system 100 includes an electronic device 10 and groups G1 and G2. The group G1 may include group devices 111 to 11n, and the group G2 may include group devices 121 to 12m. In the embodiment of the invention, the electronic device 10, the group devices 111 to 11n and the group devices 121 to 12m may be individually a tablet computer, a laptop, a smart mobile phone or other similar communication devices, but may be not limited to these.

In an embodiment, the group devices 111 to 11n in the group G1, for example, are devices located in the same conference room (or other similar occasions), and individual group devices have been mutually recognized as devices belonging to the group G1 through a method of the invention. Similarly, the group devices 121 to 12m in the group G2 are also mutually recognized as devices belonging to the group G2 through the method of the invention. It should be known that the group G1, the group G2, the group devices 111 to 11n and the group devices 121 to 12m are merely drawn in FIG. 1, but are merely used as examples and not configured to limit possible implementations of the invention. In other embodiments, there may be more/less groups and group devices in the system 100 simultaneously.

In the embodiment of the invention, the electronic device 10 not yet belonging to any group may utilize the method proposed by the invention as well to join the group G1, the group G2 or other similar groups, or even self-establish a new group. The related details will be described in detail later.

In FIG. 1, the electronic device 10 may include a storage circuit 12 and a processor 14. The storage circuit 12, for example, is any form of a fixed or mobile random access memory (RAM), a read-only memory (ROM), a flash memory, a hard disk or other similar devices or a combination of these devices, and may be configured to record a plurality of program codes or modules.

The processor 14 is coupled to the storage circuit 12, and may be a general-purpose processor, a special processor, a traditional processor, a digital signal processor, a plurality of microprocessors, one or more microprocessors combined with digital signal processor cores, a controller, a microcontroller, an application specific integrated circuit (ASIC), a field programmable gate array (FPGA) circuit, any other type of integrated circuit, a state machine, a processor based on an advanced RISC machine (ARM), and similar products.

In addition, all the group devices in FIG. 1 are roughly the same in structure, and also similar in performed operations, and thus the group device 111 is merely illustrated below as an example. The group device 111 may include a storage circuit 111a and a processor 111b. For individual possible implementations of the storage circuit 111a and the processor 111b, reference may be made to the storage circuit 12 and the processor 14, and the descriptions thereof are omitted herein.

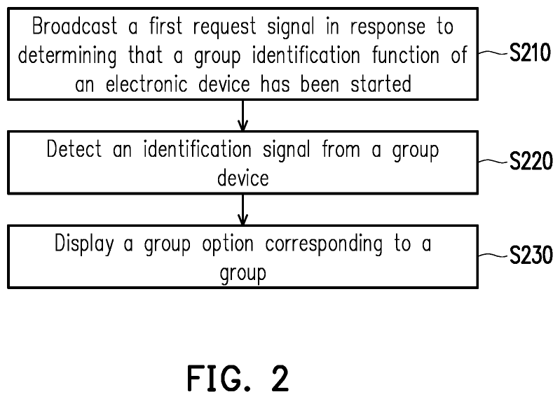

In the embodiment of the invention, the processors 14 and 111b may access modules and program codes recorded in the storage circuits 12 and 111a respectively so as to perform a method for identifying existing groups in FIG. 2, and the details thereof are specified as follows.

Referring to FIG. 2, which is a flow diagram of a method for identifying existing groups drawn according to an embodiment of the invention, first, in step S210, the processor 14 may broadcast a first request signal R1 in response to determining that a group identification function of the electronic device 10 has been started.

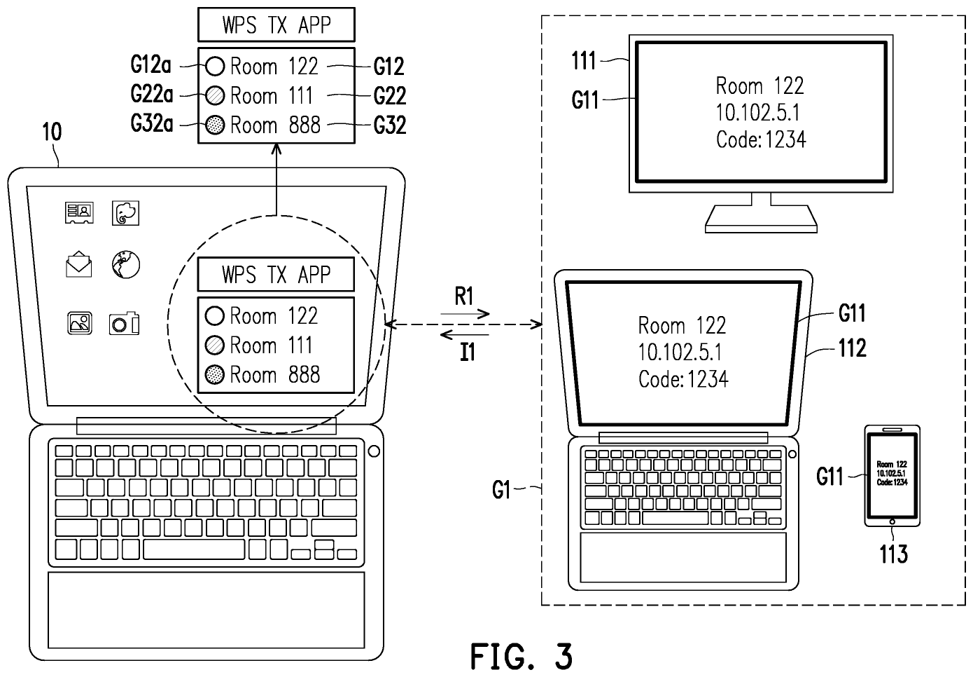

In the embodiment of the invention, each of the electronic device 10, group devices 111 to 11n and group devices 121 to 12m may be provided with a specific application program (such as, a WPS TX APP shown in FIG. 3). This application program may be configured to make corresponding devices perform operations such as identifying groups, joining the groups and establishing groups, but is not limited to these. In an embodiment, when a user of the electronic device 10 is about to control the electronic device 10 to perform one of the above operations, the group identification function may be started in the above specific application program. Correspondingly, the electronic device 10 may broadcast the first request signal R1.

In the embodiment of the invention, the group G1 and the group G2 may correspond to different group patterns. The first request signal R1 may be configured to trigger all the group devices 111 to 11n to display a group pattern (called a first group pattern below) corresponding to the group G1, and trigger the group devices 121 to 12m to display a group pattern (called a second group pattern below) corresponding to the group G2.

Taking the group device 111 as an example, the group device 111 may display the group pattern corresponding to the group G1 on its display device when detecting the first request signal R1 broadcast by the electronic device 10. This group pattern, for example, may include a picture frame, and this picture frame may be displayed on at least one of a plurality of edges of a display device of the group device 121. In other embodiments, the above group pattern may also be geometric figures having specific colours and displayed on edges of display devices, such as a triangle, a circle and a heart shape, but may be not limited to these.

Similarly, other group devices (such as the group device 11n) belonging to the group G1 may all correspondingly display the group pattern corresponding to the group G1 on their individual display devices after detecting the first request signal R1 broadcast by the electronic device 10.

In addition, the group devices 121 to 12m belonging to the group G2 may correspondingly display the group pattern corresponding to the group G2 on their individual display devices after detecting the first request signal R1 broadcast by the electronic device 10. The group pattern of the group G2 may be different from the group pattern of the group G1.

In an embodiment, it is assumed that the electronic device 10 and the group devices 111 to 11n of the group G1 are all located in a conference room A, and the electronic device 10 is about to join the group G1. In this case, when the electronic device 10 broadcasts the first request signal R1 due to starting of the group identification function, individual display devices of the group devices 111 to 11n located in the conference room A all display the group pattern corresponding to the group G1. In this way, the user of the electronic device 10 may visually observe the group pattern corresponding to the group G1 which the electronic device is about to join on the display devices of the group devices 111 to 11n.

In addition, in an embodiment, all the group devices 111 to 11n may broadcast identification signals I1 corresponding to the group G1 continuously/intermittently. The identification signals I1 may indicate the group pattern of the group G1. In an embodiment, the above specific application program, for example, may be configured with a plurality of available group patterns. In this case, the above identification signals I1 may utilize the plurality of above available group patterns to indicate the group pattern corresponding to the group G1, but the invention may be not limited to this. In addition, in an embodiment, users of the group devices 111 to 11n may further set a group name (such as “conference room A”) of the group G1 through the above specific application program. The identification signals I1 may indicate the group name of the group G1 together, but may be not limited to this.

Similarly, all the group devices 121 to 12m may also broadcast identification signals I2 corresponding to the group G2 continuously/intermittently. The identification signals I2 may indicate the group pattern and/or a group name of the group G2.

Correspondingly, in step S220, the processor 14 may detect the identification signals I1 and the identification signals I2 from the group devices 111 to 11n and the group devices 121 to 12m. In an embodiment, since the identification signals I1 and the identification signals I2 individually indicate the group patterns and group names of the group G1 and the group G2, the electronic device 10 may know which of the above available group patterns is used as the first group pattern (such as the picture frame) by the group G1 based on the identification signals I1. In the same way, the electronic device 10 may also know which of the above available group patterns is used as the second group pattern (such as the circle) by the group G2 based on the identification signals I2.

Afterwards, in step S230, the processor 14 may display group options corresponding to the groups G1 and G2. The group option (called a first group option below) corresponding to the group G1 may indicate the first group pattern, and the group option (called a second group option below) corresponding to the group G2 may indicate the second group pattern. As mentioned previously, under the situation that the user of the electronic device 10 is about to make the electronic device 10 join the group G1, since the user of the electronic device 10 may visually observe the first group pattern displayed by the display devices of the group devices 111 to 11n, the user of the electronic device 10 may easily find the first group option having the first group pattern as well from all group options displayed by the electronic device 10.

From the foregoing, compared with a method taking text as a main basis for identifying groups in the related art, the method of the invention can make the user identify a group which an electronic device is about to join more easily. For users of all group devices, since group patterns displayed by all the group devices in response to a first request signal are merely picture frames or geometric patterns located on edges of pictures, too much visual interference will not be caused to the users of the group devices, and contents displayed by original pictures will not be affected either.

In order to make the above concepts clearer, further illustrations are made below with reference to FIG. 3. Referring to FIG. 3, which is a schematic application situation diagram drawn according to FIG. 1, as shown in FIG. 3, after the electronic device 10 broadcasts the first request signal R1 due to starting of the group identification function, the group devices 111 to 113 belonging to the group G1 may correspondingly display a first group pattern Gil (such as a red picture frame) on their display devices, so as to allow the user of the electronic device 10 to confirm visually. In addition, the electronic device 10 in FIG. 3 may be a personal computer. Patterns drawn on the left of a screen of the personal computer may be different application programs, such as a mailbox, a browser, a photo and a camera. The lower right of the screen may display a related application program (WPS TX APP) of the embodiment of the invention.

At the same time, the group devices 111 to 113 may broadcast identification signals I1. The identification signals I1 may indicate the first group pattern Gil and a group name (such as “Room 122”) of the group G1. In addition, in FIG. 3, the group devices 111 to 113 may further display information related to the group G1 simultaneously, such as the group name “Room 112”, an IP address and passwords, but may be not limited to this.

Afterwards, after the electronic device 10 detects the identification signals I1 (as well as identification signals from other groups), the electronic device 10 may display a first group option G12 corresponding to the group G1, and other group options G22 and G32 corresponding to the other groups. As mentioned in the previous embodiments, the first group option G12, for example, may indicate the first group pattern Gil in a mode of displaying a red circle G12a. Similarly, the other group options G22 and G32 may indicate other group patterns by displaying circles G22a and G32a of other colours as well, but the invention may be not limited to this.

In this case, the user of the electronic device 10 may easily find the first group option G12 indicating the first group pattern Gil as well in a picture of the electronic device 10. In this case, the user of the electronic device 10 may control the electronic device 10 to join the group G1 through, for example, a mode of selecting the first group option G12, but may be not limited to this.

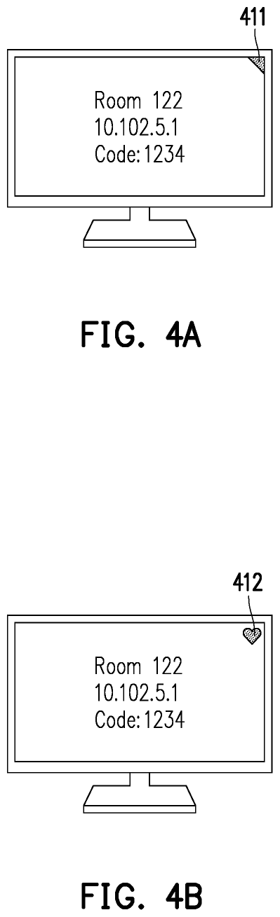

Referring to FIG. 4A and FIG. 4B, which are schematic diagrams of other group patterns drawn according to FIG. 3, as shown in FIG. 4A and FIG. 4B, besides the first group pattern Gil drawn and shown as the picture frame in FIG. 3, a first group pattern of the group G1 may be shown by adopting a group pattern 411 (such as a red triangle) and a group pattern 412 (such as a red heart shape) located on edges of the picture or other similar modes, so as to allow the user of the electronic device 10 to identify, but may be not limited to this.

In an embodiment, the processor 14 may control the electronic device 10 to join the group G1 in response to determining that the first group option G12 corresponding to the group G1 has been selected, and the first request signal R1 is stopped being broadcast. Since the electronic device 10 has become a member of the group G1, the electronic device 10 may also broadcast the identification signals I1 corresponding to the group G1 continuously/intermittently, so as to allow other electronic devices being about to join the group G1 to identify, but may be not limited to this.

In addition, in other embodiments, the electronic device 10 not yet joining any group may further display a specific group option when displaying group options corresponding to all the existing groups. This specific group option does not correspond to any existing group, and the specific group option includes a specific group pattern different from group patterns of other existing groups.

Specifically, as mentioned previously, the specific application program installed on the electronic device 10 may include the plurality of available group patterns, and may exclude the first group pattern and the second group pattern respectively corresponding to the group G1 and the group G2 from the above available group patterns after receiving the identification signals I1 and the identification signals 12. In other words, remaining available group patterns are all not yet used by any group, and therefore may be configured to establish a new group by the electronic device 10. In this case, the electronic device 10 may use the remaining available group patterns corresponding to the above specific group pattern, so as to allow the user of the electronic device 10 to select.

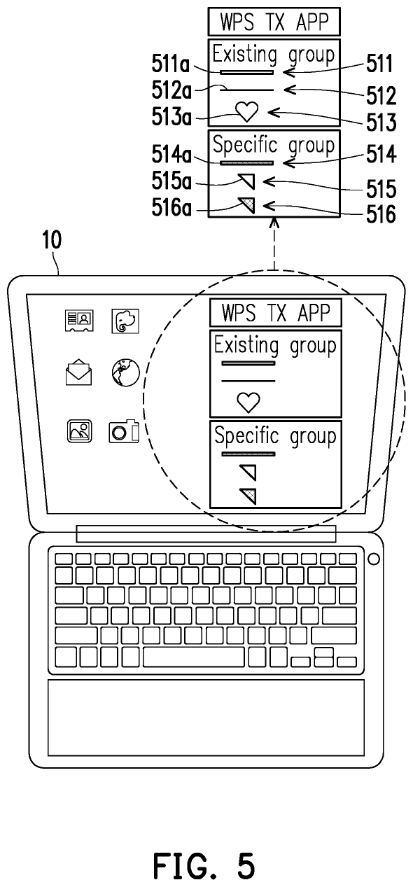

In order to make the above concepts be understood more easily, further illustrations are made below with reference to FIG. 5. Referring to FIG. 5, which is an application situation diagram drawn according to an embodiment of the invention, in FIG. 5, it is assumed that an electronic device 10 displays group options 511 to 513 in response to identification signals of all existing groups, and individual group options indicate group patterns 511a to 513a corresponding to all the existing groups. At the same time, the electronic device 10 may further display specific group options 514 to 516 not corresponding to any existing group, while individual specific group options may indicate specific group patterns 514a to 516a (individual specific group patterns are all available group patterns).

In this case, if a user of the electronic device 10 is about to establish a new group (called a specific group below), one of the specific group options 514 to 516 may be selected. Assuming that the user of the electronic device 10 selects the specific group option 514, a processor 14 may establish the specific group correspondingly, and make the electronic device 10 join this specific group. Since the specific group option 514 corresponds to the specific group pattern 514a, this specific group may use the specific group pattern 514a as a group pattern.

After the electronic device 10 establishes the above specific group, the processor 14 may broadcast a specific identification signal corresponding to the specific group continuously/intermittently. This specific identification signal may indicate the specific group pattern 514a. In short, the electronic device 10 may be understood to belong to a group device of the specific group, and may operate according to an operation mode of the group device demonstrated in the previous embodiments.

In an embodiment, this specific identification signal may be configured to allow other electronic devices (called a second electronic device below) not yet joining any group to identify the specific group where the electronic device 10 is located. That is, when receiving the above specific identification signal, the second electronic device may correspondingly display a group option corresponding to the specific group. This group option may indicate the specific group pattern 514a, so as to allow a user of the second electronic device to refer to.

In addition, the second electronic device may also broadcast its own request signal, so as to trigger other group devices to display group patterns corresponding to groups which they belong to. Taking the electronic device 10 as an example, after it establishes the specific group, if receiving the request signal from the second electronic device, the electronic device 10 may correspondingly display the specific group pattern 514a on its display device, so as to allow the user of the second electronic device to identify.

In an embodiment, if the electronic device 10 has displayed the specific group pattern 514a for a preset time (such as 10 seconds), and the second electronic device does not join the specific group in the preset time, it represents that the second electronic device may have joined other existing groups or have self-established groups, the processor 14 may stop displaying the specific group pattern 514a, so as to avoid visual interference to the user of the electronic device 10, but the invention may be not limited to this.

In an embodiment, a specific application program installed on the electronic device 10 may further have a group confirmation function. This group confirmation function may be configured to trigger other electronic devices belonging to the specific group to display the specific group pattern 514a, so as to allow the user of the electronic device 10 to confirm whether the specific group which the electronic device 10 belongs to is a needed group.

For example, it is assumed that the above second electronic device has joined the specific group according to demonstration in the previous embodiments. In this case, the user of the electronic device 10 may start the group confirmation function, and the processor 14 may correspondingly broadcast a first group confirmation signal, so as to display the specific group pattern 514a through other group devices (such as the second electronic device) of the specific group which the first group confirmation signal belongs to. At the same time, the electronic device 10 may also display the specific group pattern 514a itself.

In this case, if the user of the electronic device 10 observes that other electronic devices belonging to the same conference room A with the electronic device all do not display the specific group pattern 514a, the user of the electronic device 10 may know that the electronic device 10 and the other electronic devices in the conference room A do not belong to the same group. Therefore, the user of the electronic device 10, for example, may make the electronic device 10 join a group corresponding to the conference room A again according to the previous demonstration, but may be not limited to this.

In addition, after the electronic device 10 starts the group confirmation function, if the second electronic device does not correspondingly display the specific group pattern 514a, it represents that the second electronic device may not successfully join the specific group established by the electronic device 10. In this case, the user of the second electronic device may also control the second electronic device to join the specific group established by the electronic device 10 again according to the previous demonstration, but may be not limited to this.

In addition, the above first group confirmation signal may further be configured to trigger group devices of other groups to display corresponding group patterns, so as to allow the user of the electronic device 10 to confirm. For example, when the electronic device 10 starts the group confirmation function, the other electronic devices in the conference room A with it will also display group patterns of the groups which they belong to. In this case, the user of the electronic device 10 may visually confirm whether the specific group pattern 514a displayed by the electronic device 10 is matched with the group patterns displayed by the other electronic devices, so as to know whether all the electronic devices in the conference room A belong to the same group, but the invention may be not limited to this.

In the same way, when the electronic device 10 receives a group confirmation signal from the second electronic device or the group devices belonging to the other groups, the electronic device 10 may also correspondingly display the specific group pattern 514a, so as to allow the user to visually confirm, but may be not limited to this.

Based on the foregoing, the method proposed by the invention may make an electronic device not yet joining any group to trigger other group devices which have belonged to a group with a request signal to display group patterns corresponding to the group which the other group devices belong to, so as to allow the user of the electronic device to directly confirm visually. The electronic device may further know group patterns corresponding to all existing groups based on identification signals from all groups, and display the group patterns to allow the user to refer to. Therefore, the method of the invention may make the user of the electronic device identify a group which the electronic device is about to join more easily. For users of all group devices, since group patterns displayed by all the group devices in response to a first request signal are merely picture frames or geometric patterns located on edges of pictures, too much visual interference will not be caused to the users of the group devices, and contents displayed by original pictures will not be affected either.

In addition, when becoming a group device due to joining/establishing the group, the electronic device may also display a group pattern of the group which it belongs to in response to a request signal of the electronic device not yet belonging to any group, so as to allow a user to visually confirm. The electronic device becoming the group device may further trigger group devices belonging to the same group and/or group devices belonging to other groups by sending a group confirmation signal to display group patterns corresponding to the groups which they belong to, so as to allow the user to confirm. In addition, the electronic device becoming the group device may also display the group pattern of the group which it belongs to in response to group confirmation signals of the other group devices.

Although the invention is described with reference to the above embodiments, the embodiments are not intended to limit the invention. A person of ordinary skill in the art may make variations and modifications without departing from the spirit and scope of the invention. Therefore, the protection scope of the invention should be subject to the appended claims.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. No element and component in the disclosure is intended to be dedicated to the public regardless of whether the element or component is explicitly recited in the following claims.

What is claimed is:

1. A method for identifying existing groups, suitable for an electronic device, wherein the method comprises:
broadcasting a first request signal in response to determining that a group identification function of the electronic device has been started, wherein the first request signal is configured to trigger at least one first group device to display a first group pattern, and the first group pattern corresponds to a first group which the at least one first group device belongs to;
detecting a first identification signal from the at least one first group device, wherein the first identification signal indicates the first group pattern of the first group; and
displaying a first group option corresponding to the first group, wherein the first group option indicates the first group pattern.

2. The method according to claim 1, wherein the method further comprises:
joining the first group in response to determining that the first group option corresponding to the first group has been selected, and stopping broadcasting the first request signal.

3. The method according to claim 2, wherein the method further comprises:
broadcasting the first identification signal.

4. The method according to claim 1, wherein the method further comprises:
displaying a specific group option, wherein the specific group option does not correspond to any existing group, and the specific group option comprises a specific group pattern different from the first group pattern;
establishing a specific group in response to determining that the specific group option has been selected, and joining the specific group; and
broadcasting a specific identification signal corresponding to the specific group, wherein the specific identification signal indicates the specific group pattern.

5. The method according to claim 4, wherein the method further comprises:
displaying the specific group pattern in response to detecting a second request signal from another electronic device.

6. The method according to claim 5, wherein the method further comprises:
stopping displaying the specific group pattern in response to determining that the specific group pattern has been displayed for a preset time and determining that the another electronic device does not join the specific group within the preset time.

7. The method according to claim 1, wherein the method further comprises:
detecting a second identification signal from at least one second group device, wherein the at least one second group device belongs to a second group, and the second identification signal indicates a second group pattern corresponding to the second group; and
displaying a second group option corresponding to the second group, wherein the second group option indicates the second group pattern.

8. The method according to claim 1, wherein the first identification signal further indicates a group name of the first group, and the first group option further comprises the group name of the first group.

9. A method for identifying existing groups, suitable for a group device belonging to a first group, wherein the method comprises:
broadcasting a first identification signal, wherein the first identification signal indicates a first group pattern corresponding to the first group; and
displaying the first group pattern in response to determining that a first request signal from an electronic device is detected.

10. The method according to claim 9, wherein the method further comprises:
stopping displaying the first group pattern in response to determining that the first group pattern has been displayed for a preset time and determining that the electronic device does not join the first group within the preset time.

11. The method according to claim 9, wherein the method further comprises:
broadcasting a first group confirmation signal in response to determining that a group confirmation function has been started, wherein the first group confirmation signal is configured to trigger other group devices belonging to the first group to display the first group pattern.

12. The method according to claim 11, wherein the first group confirmation signal is further configured to trigger at least one second group device belonging to a second group to display a second group pattern corresponding to the second group.

13. The method according to claim 9, wherein the method further comprises:
displaying the first group pattern in response to determining that a second group confirmation signal is detected, wherein the second group confirmation signal is from other group devices belonging to the first group or from a second group device belonging to a second group.

14. The method according to claim 9, wherein the group device has a device picture, and the first group pattern comprises at least one of a picture frame displayed in the device picture and a specific icon displayed at an edge of the device picture.

15. An electronic device, comprising a storage circuit and a processor, wherein:
the storage circuit is configured to store a plurality of modules;
the processor is coupled to the storage circuit, and configured to access the plurality of modules to perform:
broadcasting a first request signal in response to determining that a group identification function of the electronic device has been started, wherein the first request signal is configured to trigger at least one first group device to display a first group pattern, and the first group pattern corresponds to a first group which the at least one first group device belongs to;
detecting a first identification signal from the at least one first group device, wherein the first identification signal indicates the first group pattern of the first group; and
displaying a first group option corresponding to the first group, wherein the first group option indicates the first group pattern.

16. The electronic device according to claim 15, wherein the processor is further disposed to:
join the first group in response to determining that the first group option corresponding to the first group has been selected, and stop broadcasting the first request signal.

17. The electronic device according to claim 16, wherein the processor is further disposed to:
broadcast the first identification signal.

18. The electronic device according to claim 15, wherein the processor is further disposed to:
display a specific group option, wherein the specific group option does not correspond to any existing group, and the specific group option comprises a specific group pattern different from the first group pattern;
establish a specific group in response to determining that the specific group option has been selected, and join the specific group; and
broadcast a specific identification signal corresponding to the specific group, wherein the specific identification signal indicates the specific group pattern.

19. The electronic device according to claim 18, wherein the processor is further disposed to:
display the specific group pattern in response to detecting a second request signal from another electronic device.

20. The electronic device according to claim 19, wherein the processor is further disposed to:
stop displaying the specific group pattern in response to determining that the specific group pattern has been displayed for a preset time and determining that the another electronic device does not join the specific group within the preset time.

21. The electronic device according to claim 15, wherein the processor is further disposed to:
detect a second identification signal from at least one second group device, wherein the at least one second group device belongs to a second group, and the second identification signal indicates a second group pattern corresponding to the second group; and
display a second group option corresponding to the second group, wherein the second group option comprises the second group pattern.

22. The electronic device according to claim 15, wherein the first identification signal further indicates a group name of the first group, and the first group option further comprises the group name of the first group.

23. A group device, comprising a storage circuit and a processor, wherein
the storage circuit is configured to store a plurality of modules; and
the processor is coupled to the storage circuit, and configured to access the plurality of modules to perform:
broadcasting a first identification signal, wherein the group device belongs to a first group, and the first identification signal indicates a first group pattern corresponding to the first group; and
displaying the first group pattern in response to determining that a first request signal from an electronic device is detected.

24. The group device according to claim 23, wherein the processor is further disposed to:
stop displaying the first group pattern in response to determining that the first group pattern has been displayed for a preset time and determining that the electronic device does not join the first group within the preset time.

25. The group device according to claim 23, wherein the processor is further disposed to:
broadcast a first group confirmation signal in response to determining that a group confirmation function has been started, wherein the first group confirmation signal is configured to trigger other group devices belonging to the first group to display the first group pattern.

26. The group device according to claim 25, wherein the first group confirmation signal is further configured to trigger at least one second group device belonging to a second group to display a second group pattern corresponding to the second group.

27. The group device according to claim 23, wherein the processor is further disposed to:
display the first group pattern in response to determining that a second group confirmation signal is detected, wherein the second group confirmation signal is from other group devices belonging to the first group or from a second group device belonging to a second group.

28. The group device according to claim 23, wherein the group device is provided with a display device, the display device displays the first group pattern, the first group pattern comprises a picture frame, and the picture frame is displayed on at least one of a plurality of edges of the display device.
